(19) United States
(12) Patent Application Publication
(10) Pub. No.: US 2009/0051478 A1
(43) Pub. Date: Feb. 26, 2009

(54) FILTER AND MANUFACTURING METHOD THEREOF

(76) Inventors: Cheng-Hong Lee, Taoyuan Hsien (TW); Yu-Lin Hsueh, Taoyuan Hsien (TW); Yi-Hong Huang, Taoyuan Hsien (TW)

Correspondence Address: BIRCH STEWART KOLASCH & BIRCH, PO BOX 747, FALLS CHURCH, VA, 22040-0747, US

(21) Appl. No.: 12/027,855

(22) Filed: Feb. 7, 2008

(30) Foreign Application Priority Data
Aug. 20, 2007 (TW) 096130659

(51) Int. Cl. H01F 27/26; H01F 27/255; H01F 41/02

(52) U.S. Cl. 336/212; 29/606; 336/221

(57) ABSTRACT

A filter includes a first magnetic ring, a second magnetic ring, two windings and a magnetically conductive element. The second magnetic ring covers the first magnetic ring. The windings are wound around the second magnetic ring, respectively, and the magnetically conductive element is assembled with the second magnetic ring.

### CROSS REFERENCE TO RELATED APPLICATIONS

This Non-provisional application claims priority under 35 U.S.C. §119(a) on Patent Application No(s). 096130659 filed in Taiwan, Republic of China on Aug. 20, 2007, the entire contents of which are hereby incorporated by reference.

### BACKGROUND OF THE INVENTION

1. Field of Invention

The invention relates to a filter having a small size and windings that can be wound more simply, and a manufacturing method thereof.

2. Related Art

Recently, applications of electronic circuits are getting wider, and such circuits usually operate in high-frequency switching and tend to generate electromagnetic interference (EMI). These high-frequency noises are conducted through electro-magnetic radiation or power lines to interfere with normal operations of other electronic apparatuses. The conductive EMI can be classified into a differential mode (DM) noise and a common mode (CM) noise according to different transfer paths of noise currents. In practice, a filter such as a choke is usually utilized to eliminate the conductive EMI.

Referring to FIG. 1, a conventional choke 1 includes an insulating body 11, a common mode core 12, a differential mode core 13, a first winding 14 and a second winding 15.

The insulating body 11 separates the common mode core 12 from the differential mode core 13. The differential mode core 13 has a rod-like portion 13a and a ring portion 13b, which are integrally formed as a monolithic piece. The first winding 14 and the second winding 15 are separated from each other by the rod-like portion 13a and are wound around two sides of the choke 1 respectively. Therefore, after the conductive EMI enters the choke 1, the common mode core 12 can eliminate the common mode noise, and the differential mode core 13 can eliminate the differential mode noise.

However, when the size of the choke 1 is gradually reduced, the winding space for the windings is reduced due to the hindrance of the rod-like portion 13a. Thus, the difficulty of winding the windings is increased, and the risk of scratching the windings also exists.

Therefore, it is an important subject to provide a filter having a reduced size and windings that can be easily wound, and a manufacturing method thereof.

### SUMMARY OF THE INVENTION

In view of the foregoing, the invention is to provide a filter having a reduced size and windings that can be easily wound, and a manufacturing method thereof.

To achieve the above, the invention discloses a filter including a first magnetic ring, a second magnetic ring, two windings and a magnetically conductive element. The second magnetic ring covers the first magnetic ring. The two windings wound around the second magnetic ring. The magnetically conductive element is assembled with the second magnetic ring wound with the windings.

In addition, the invention also discloses a manufacturing method of a filter including the following steps of: enclosing a first magnetic ring with a second magnetic ring, winding two windings around the second magnetic ring, respectively, and assembling a magnetically conductive element with the second magnetic ring.

As mentioned above, the filter of the invention has the second magnetic ring, which is for eliminating the differential mode noise and covers the first magnetic ring for eliminating the common mode noise. In addition, the detachable magnetically conductive element can be detached to enlarge the winding space when the windings are being wound. After the windings are completely wound, the magnetically conductive element is combined with the second magnetic ring so that the filter is manufactured. Thus, it is possible to avoid the problem of the difficulty in winding the windings due to the reduced size of the filter.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention, and wherein:

FIG. 1 is a schematic illustration showing a conventional choke;

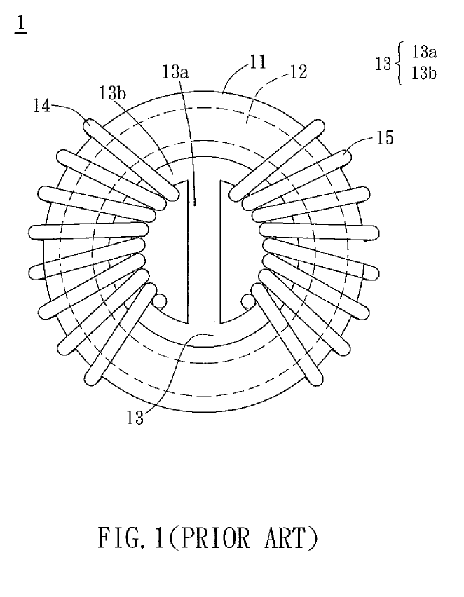

FIGS. 2A and 2B are schematic illustrations showing a filter according to a first embodiment of the invention;

FIG. 3 is a schematic illustration showing another aspect of the filter according to the first embodiment of the invention;

FIGS. 4A and 4B are schematic illustrations showing operations of the filter of the invention;

FIG. 5 is a schematic illustration showing a filter according to a second embodiment of the invention;

FIG. 6 is a schematic illustration showing a filter according to a third embodiment of the invention;

FIGS. 7A and 7B are schematic illustrations showing another aspect of a magnetically conductive element of the filter according to the third embodiment of the invention; and

FIG. 8 is a flow chart showing steps in a manufacturing method of the filter of the invention.

### DETAILED DESCRIPTION OF THE INVENTION

The present invention will be apparent from the following detailed description, which proceeds with reference to the accompanying drawings, wherein the same references relate to the same elements.

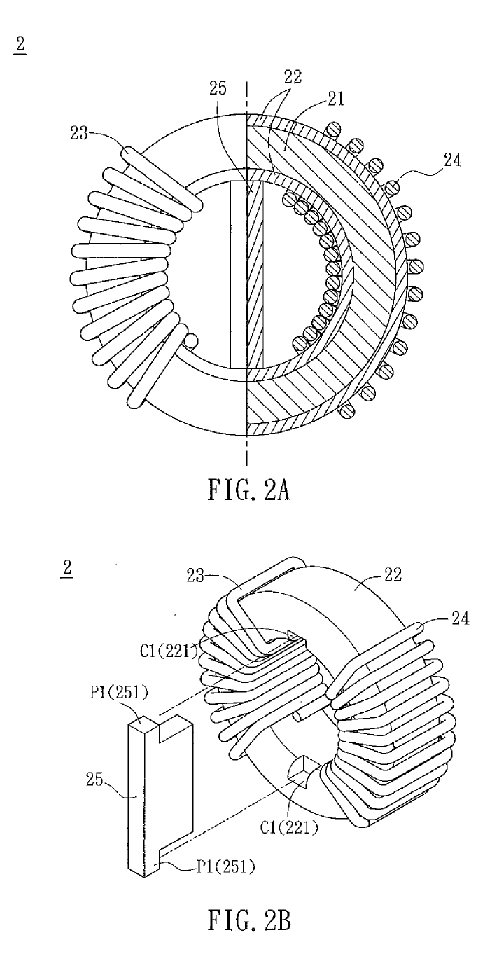

Referring to FIGS. 2A and 2B, a filter 2 according to a first embodiment of the invention includes a first magnetic ring 21, a second magnetic ring 22, two windings 23 and 24 and a magnetically conductive element 25.

The material of the first magnetic ring 21 can be ferrite, amorphous material or a mixture thereof. The first magnetic ring 21 is a common mode core for eliminating the common mode noise.

The material of the second magnetic ring 22 can be polymer, magnetic filler or a mixture thereof. The magnetic filler can be made of ferrite, iron-containing magnetic powder or a mixture thereof. The second magnetic ring 22 covers the first magnetic ring 21 and is a differential mode core for eliminating the differential mode noise.

The windings 23 and 24 are wound around the second magnetic ring 22, respectively, wherein the winding 23 is wound around a left half portion of the second magnetic ring 22, and the winding 24 is wound around a right half portion of the second magnetic ring 22.

The material of the magnetically conductive element 25 can be the same as or different from that of the second magnetic ring 22. For example, the second magnetic ring 22 is composed of the polymer and the iron-containing magnetic powder, and the magnetically conductive element 25 is composed of the polymer and the ferrite. The magnetically conductive element 25 is also for eliminating the differential mode noise. In addition, two end portions of the magnetically conductive element 25 are connected to an inner ring surface of the second magnetic ring 22, respectively. The magnetically conductive element 25 has a first connecting portion 251, and the second magnetic ring 22 has a second connecting portion 221. The first connecting portion 251 can include at least one projecting portion P1, while the second connecting portion 221 may include at least one concave portion C1. In this embodiment, the first connecting portion 251 has two projecting portions P1, and the second connecting portion 221 has two concave portions C1. Therefore, the magnetically conductive element 25 and the second magnetic ring 22 can be engaged with each other by the first connecting portion 251 and the second connecting portion 221.

Consequently, the magnetically conductive element 25 can be detached to enlarge the winding space when the windings 23 and 24 are wound. After the windings 23 and 24 are completely wound, the magnetically conductive element 25 is connected with the second magnetic ring 22 so that the filter 2 is manufactured. Thus, it is possible to avoid the problem of the difficulty in winding the windings 23 and 24 due to the reduced size of the filter 2.

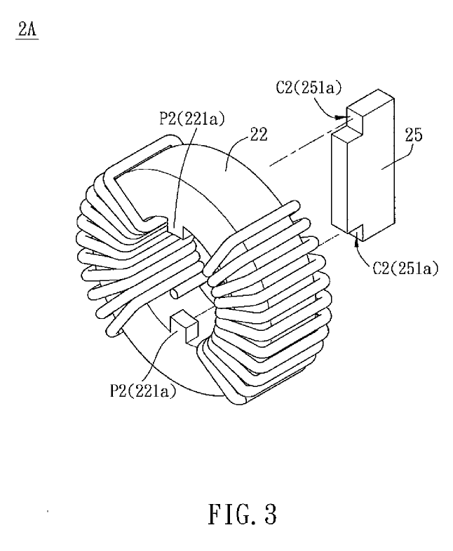

In addition, as shown in FIG. 3, what is different from the filter 2 is that a filter 2A of FIG. 3 has a first connecting portion 251a having at least one concave portion C2, and a second connecting portion 221a having at least one projecting portion P2, which can be combined with the concave portion C2. Herein, the first connecting portion 251a has two concave portions C2, and the second connecting portion 221a has two projecting portions P2. It is to be noted that the first connecting portion 251a and the second connecting portion 221a can be designed according to, without limitation to, the manner of this embodiment, or according to the preferential consideration of combining the magnetically conductive element 25 with the second magnetic ring 22.

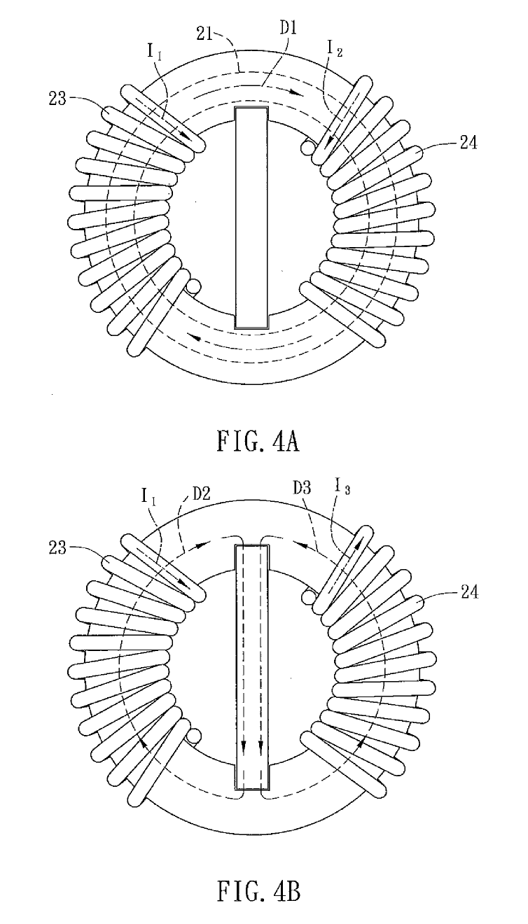

As shown in FIG. 4A, when currents flow through the two windings 23 and 24 in directions I1 and I2, and a magnetic field with a direction D1 is generated on the first magnetic ring 21. The magnetic field then circulates through the closed magnetic loop and is converted into heat energy consumed through vortexes. Thus, the common mode noise current is gradually consumed to eliminate the common mode noise.

Next, as shown in FIG. 4B, when the currents flow through the windings 23 and 24 in the directions I1 and I3, magnetic fields with directions D2 and D3 are generated on the second magnetic ring 22 and the magnetically conductive element 25. The two magnetic fields circulate through the left half portion or the right half portion of the second magnetic ring 22 and the magnetically conductive element 25, respectively, to constitute the closed magnetic loop, and are converted into the heat energy consumed through the vortexes. Thus, the differential mode noise current is gradually consumed to eliminate the differential mode noise.

Therefore, the filter 2 of this embodiment can simultaneously eliminate the common mode noise and tie differential mode noise. In addition, because the magnetic fields generated by the currents in the filter 2 circulate in the closed magnetic loop, it is possible to prevent the filter 2 from being influenced by magnetic fields generated by peripheral elements, or to prevent the leakage inductance generated by the filter 2 from influencing the peripheral elements so that the stability of the filter 2 can be significantly enhanced.

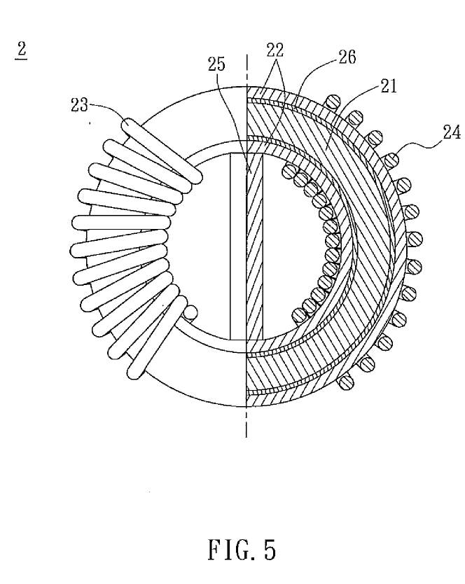

In addition, a second embodiment of the invention as shown in FIG. 5 differs from the first embodiment in that an insulating layer 26 is further disposed between the first magnetic ring 21 and the second magnetic ring 22 in order to prevent the first and second magnetic rings 21, 22 from interfering with each other.

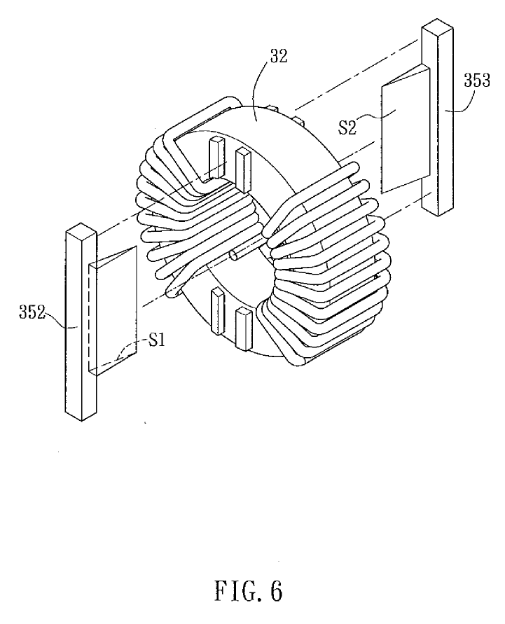

As shown in FIG. 6, a filter 3 according to a third embodiment of the invention differs from the filter 2 of the first embodiment in that a magnetically conductive element 35 of the filter 3 further includes a first sub-magnetic element 352 and a second sub-magnetic element 353, both of which are correspondingly connected with each other. Each of the first sub-magnetic element 352 and the second sub-magnetic element 353 has a connecting surface S1/S2. In this embodiment, the two connecting surfaces S1 and S2 are inclined surfaces. Therefore, the first sub-magnetic element 352 and the second sub-magnetic element 353 can correspondingly contact with each other through the two connecting surfaces S1 and S2, and may be connected with each other by engaging, fastening or adhering. In addition, the materials and the arrangements of a first magnetic ring (not shown), a second magnetic ring 32 and the magnetically conductive element 35 are the same as those of the first embodiment, so detailed descriptions thereof will be omitted.

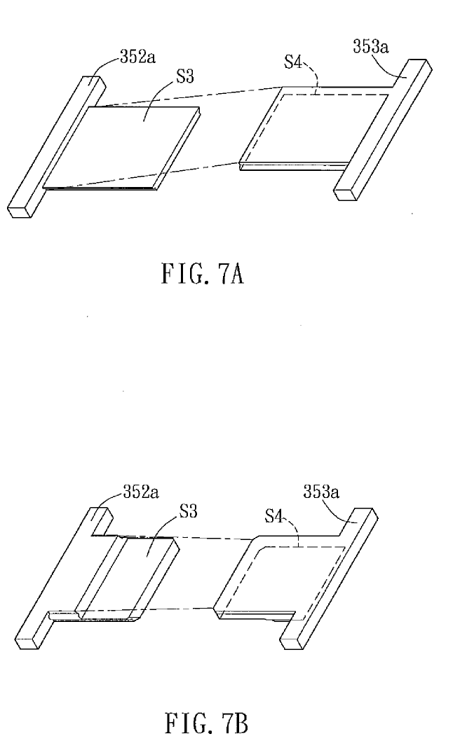

In addition, as shown in FIGS. 7A and 7B, two connecting surfaces S3 and 84 of a first sub-magnetic element 352a and a second sub-magnetic element 353a can also respectively be flat surfaces (see FIG. 7A) or respectively be ladder-like surfaces (see FIG. 7B). It is to be noted that the connecting surfaces S3 and S4 are designed according to, without limitation to, the manner of this embodiment, or according to the preferential consideration of tightly combining the first sub-magnetic element 352a with the second sub-magnetic element 353a.

The operations of the filter 3 of this embodiment are the same as those of the first embodiment, so detailed descriptions thereof will be omitted.

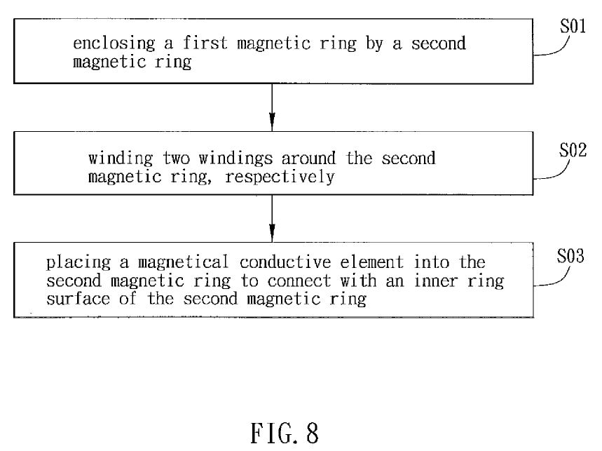

Referring to FIG. 8, a manufacturing method of the filter of the invention includes steps S01 to S03.

In the step S01, a second magnetic ring covers a first magnetic ring.

In the step S02, two windings are wound around the second magnetic ring, respectively.

In the step S03, a magnetically conductive element is placed into the second magnetic ring to connect with an inner ring surface of the second magnetic ring.

Because the structure, the material and the operations of the filter have been specified in the embodiment, detailed descriptions thereof will be omitted.

In summary, the filter of the invention has the second magnetic ring, which is for eliminating the differential mode noise and covers the first magnetic ring for eliminating the common mode noise. In addition, the detachable magnetically conductive element can be detached to enlarge the winding space when the windings are being wound. After the windings are completely wound, the magnetically conductive element is combined with the second magnetic ring so that the filter is manufactured. Thus, it is possible to avoid the problem of the difficulty in winding the windings due to the reduced size of the filter.

In addition, the magnetic fields generated in the filter of the invention due to the conductive EMI circulate in the closed magnetic loop. Thus, it is possible to prevent the filter from being influenced by the magnetic fields generated by the peripheral elements, or to prevent the leakage inductance generated by the filter from influencing the peripheral elements. Thus, the stability of the filter may also be significantly enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A filter comprising:
a first magnetic ring;
a second magnetic ring enclosed the first magnetic ring;
two windings wound around the second magnetic ring, respectively; and
a magnetically conductive element assembled with the second magnetic ring, wherein the magnetically conductive element, the first magnetic ring and the second magnetic ring are separate elements.

2. The filter according to claim 1, wherein the second magnetic ring and the magnetically conductive element arc differential mode cores.

3. The filter according to claim 1, wherein material of the second magnetic ring is polymer, magnetic filler or a mixture thereof.

4. The filter according to claim 1, wherein material of the magnetically conductive element is polymer, magnetic filler or a mixture thereof and the magnetic filler is ferrite, iron-containing magnetic powder or a mixture thereof.

5. The filter according to claim 1, wherein the second magnetic ring is composed of polymer and iron-containing magnetic powder, and the magnetically conductive element is composed of polymer and ferrite.

6. The filter according to claim 1, wherein the first magnetic ring is a common mode core.

7. The filter according to claim 1, wherein material of the first magnetic ring is ferrite, amorphous material or a mixture thereof.

8. The filter according to claim 1, wherein the magnetically conductive element has a first connecting portion, the second magnetic ring has a second connecting portion connected with the first connecting portion.

9. The filter according to claim 8, wherein the first connecting portion comprises at least one concave portion or at least one projecting portion.

10. The filter according to claim 8, wherein the second connecting portion comprises at least one concave portion or at least one projecting portion.

11. The filter according to claim 1, wherein the magnetically conductive element has a first sub-magnetic element and a second sub-magnetic element, both of which are correspondingly connected with each other.

12. The filter according to claim 11, wherein each of the first sub-magnetic element and the second sub-magnetic element has a connecting surface, and the two connecting surfaces contact with each other when the first sub-magnetic element and the second sub-magnetic element are correspondingly connected with each other.

13. The filter according to claim 12, wherein each of the connecting surfaces is a flat, inclined or ladder-like surface.

14. The filter according to claim 11, wherein the first sub-magnetic element and the second sub-magnetic element are connected with each other by engaging, fastening or adhering.

15. The filter according to claim 1, further comprising an insulating layer disposed between the first and second magnetic rings.

16. A manufacturing method of a filter, comprising steps of:
enclosing a first magnetic ring with a second magnetic ring;
winding two windings around the second magnetic ring, respectively; and
assembling a magnetically conductive element with the second magnetic ring.

17. The method according to claim 16, wherein the magnetically conductive element has a first sub-magnetic element and a second sub-magnetic element, and the step of assembling the magnetically conductive element with the second magnetic ring further comprises sub-steps of:
placing the first stub-magnetic element into an opening of the second magnetic ring from one side of the opening of the second magnetic ring to connect with an inner ring surface of the second magnetic ring;
placing the second sub-magnetic element into the opening of the second magnetic ring from the other side of the opening of the second magnetic ring to connect with the inner ring surface of the second magnetic ring; and
correspondingly connecting the first sub-magnetic element with the second sub-magnetic element.

18. The method according to claim 17, wherein each of the first sub-magnetic element and the second sub-magnetic element has a connecting surface, a flat surface, an inclined surface or a ladder-like surface so that the first sub-magnetic element and the second sub-magnetic element are connected with each other.

19. The method according to claim 17, wherein the first and second sub-magnetic elements are connected with each other by engaging, fastening or adhering.

20. The method according to claim 16, wherein after the first magnetic ring is enclosed by an insulating layer, the method further comprises a step of enclosing the second magnetic ring with the insulating layer.
